(19) United States
(12) Patent Application Publication
(10) Pub. No.: US 2021/0235642 A1
(43) Pub. Date: Aug. 5, 2021

(54) Plant Water Feeder

(71) Applicant: Yevhen Ruchko, Mill Valley, CA (US)

(72) Inventor: Yevhen Ruchko, Mill Valley, CA (US)

(21) Appl. No.: 16/780,799

(22) Filed: Feb. 3, 2020

(51) Int. Cl. A01G 27/00

(52) U.S. Cl. CPC A01G 27/005; A01G 27/001; A01G 27/008

(57) ABSTRACT

A disclosed plant watering structure comprises of a reservoir partially filled with water, one tube supplying water from the reservoir to a watering plant, another tube which allows air to the water in the reservoir. Adjusting the distance between the end of this tube and the bottom of the reservoir, creates a balance of pressure in the system, which allows water flow into the plant only when the plant needs watering.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains to the field of plant water feeding. Water provides structural support, cools plan down, and moves minerals to all the right places. When there is a lack of water, plant cells deflate, and the plant looks wilted. Plants produce cellulose that keep its shape, but it is water pressure (water flowing through a plant) that helps plants gain and retain their shape better than cellulose alone.

Plant soil is like a sponge. Most houseplants like a porous soil, allowing room for water and air pockets. A plant should absorb water slowly through its roots. Different plants need varying amounts of water. Plant size also determines how much water a plant needs. In smaller pots with less soil, the soil will dry out faster than in larger pots with lots of soil. Between the two of the same plant with one larger than other, one will need water more often than the other. For larger plants, water needs to soak in until soil is saturated. For smaller plants a semi-soak is usually better. Plants can drown if they are flooded with too much water. If soil is left too wet for too long, it can cause root rot. Letting a soil dry out before watering is key for plants to receive the perfect balance of water and oxygen. For most plants, watering is needed when the soil is dry—not just surface dry, but 2-inches-deep dry.

There is a need in the market for a simple and economical product and system that waters plants without expensive mechanisms, electricity requirements, and supplying water when needed and in a required quantity by plants.

### BRIEF SUMMARY OF THE INVENTION

A disclosed plant watering structure comprises of a reservoir partially filled with water, one tube supplying water from the reservoir to a watering plant, another tube which allows air to the water in the reservoir. Adjusting the distance between the end of this tube and the bottom of the reservoir, creates a balance of pressure in the system, which allows water flow into the plant only when the plant needs watering. The tube with water and the tube with air have the same diameter. The reservoir and the watering plant are located on the same level.

Other aspects and advantages of embodiments of the disclosure will become apparent from the following detailed description, taken in conjunction with the accompanying drawing, illustrated by way of example of the principles of the disclosure.

### BRIEF DESCRIPTION OF THE DRAWING

FIG. 1 depicts a transparent view of a plant watering system and environment in accordance with an embodiment of the present disclosure.

Although specific embodiments of the invention have been illustrated, the invention is not to be limited to the specific forms or arrangements of parts so described and illustrated. The scope of the invention is to be defined by the claims appended hereto and their equivalents.

### DETAILED DESCRIPTION OF THE INVENTION

Reference will now be made to exemplary embodiments illustrated in the drawing and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

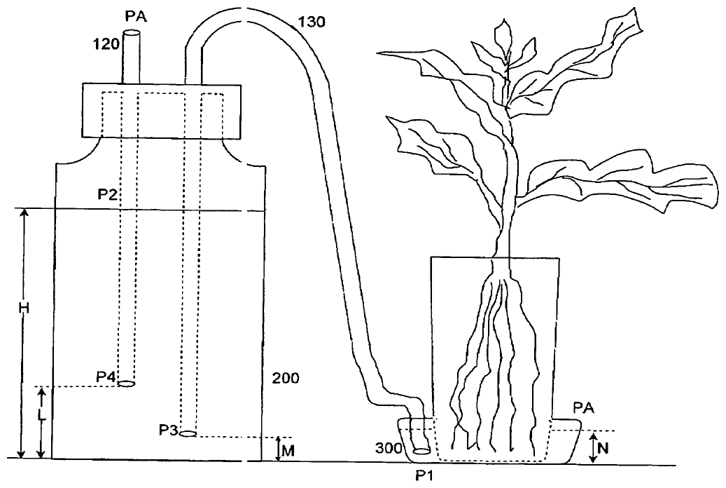

FIG. 1 depicts a transparent view of a plant watering system and environment in accordance with an embodiment of the present disclosure. A support surface for the watering fluid reservoir is on the same level as a support surface for the plant to be watered by the system. The reservoir 200 may comprise a plastic bottle or other household or custom container. The system includes a 120 vertical tube inserted into the reservoir tank/bottle providing air access inside the reservoir, another tube 130 supplying water to the plate 300 under the plant and a 200 Disposable/recycled Water Reservoir (e.g. large plastic water bottle).

The pressure in the point where water gets into the plate under the plant:

P1=PA+G×N×R,

where PA is atmospheric pressure, G is local gravitational field strength (forth/unit mass), N is height of water in the plate, and R is the density of water (mass/unit mass). For water under standard conditions, G=9.8 m/s², and R is 1000 kg/m³.

The pressure in the point where air gets into the water should equal atmospheric pressure in order to air not get into the water and inside the reservoir:

P4=P2+G×(H−L)×R=PA,

where P2 is pressure inside the reservoir under the lid above water, H is height of water in the reservoir, L is distance between the lower end of the tube with air and the bottom of the reservoir.

On the other hand,

P3=P2+G×(H−M)×R=P4,

only in this case the system will be static: the air will not enter into the water in the reservoir, water is not flowing through the tube to the plant.

P3 is pressure where water enters the tube connecting with the plant, M is distance between lower the end of the tube supplying water and the bottom of the reservoir.

If the system is static, P3=P1:

P2+G×(H−M)×R=PA+G×N×R,

since P2+G×(H−L)×R=PA,

P2+G×(H−M)×R=P2+G×(H−L)×R+G×N×R,

or, N=L−M,

it means, the level of water in the plate under the plant will equal the difference between the level of air entrance into the reservoir and the level of water in-take in the reservoir.

1. A plant watering structure comprising: a reservoir and a potted plant connected with a tube.
The plant watering structure of claim [0014], wherein the reservoir is partially filled with water. The reservoir is closed with a lid. Air is above water in the reservoir.
The plant watering structure of claim [0014], further comprising two tubes through the lid of the reservoir wherein the tubes have the same diameter. One tube transfers water to the plate under the watering plant, another tube provides air access to water in the reservoir.
The plant watering structure of claim [0014], wherein the height of the plate under the plant is taller than the height difference between the level of air entrance into water and the level of water in-take in the reservoir.
